(19) United States
(12) Patent Application Publication
(10) Pub. No.: US 2025/0386123 A1
(43) Pub. Date: Dec. 18, 2025

(54) WAVELENGTH DIVISION MULTIPLEXING (WDM)-BASED OPTICAL SWITCHES

(71) Applicant: Lightmatter, Inc., Boston, MA (US)

(72) Inventors: Alexander Sludds, Cambridge, MA (US); Daniel Stodolsky, Cambridge, MA (US)

(73) Assignee: Lightmatter, Inc., Boston, MA (US)

(21) Appl. No.: 19/240,079

(22) Filed: Jun. 17, 2025

Related U.S. Application Data
(60) Provisional application No. 63/661,303, filed on Jun. 18, 2024.

(51) Int. Cl. H04Q 11/00; H04J 14/02

(52) U.S. Cl. CPC H04Q 11/0005; H04J 14/0212; H04J 14/0221; H04Q 2011/0016

(57) ABSTRACT

Described herein are optical switches that leverage wavelength division multiplexing (WDM) to route signals to the desired output. The optical switches developed by the inventors represent significant advancements over conventional designs in several critical areas. A switching scheme uses WDM to route signals to the desired destination. Each source/destination pair may be encoded on a particular WDM channel. For example, a device that intends to transmit a message from an input port to a particular output port may encode the message on a WDM channel that is uniquely associated with that output port. This approach presents a significant advantage over conventional switching architectures in that it removes the requirement to use stages of electrical routing, thereby reducing power consumption and signal latency. Instead, routing is performed on the basis of WDM channels.

### CROSS-REFERENCE TO RELATED APPLICATION

This application claims the benefit under 35 U.S.C. § 119(e) of U.S. Provisional Patent Application Ser. No. 63/661,303 filed Jun. 18, 2024, under Attorney Docket No. L0858.70090US00 and entitled “DATA MOVEMENT IN A PHOTONICALLY-CONNECTED DISTRIBUTED NETWORK,” which is hereby incorporated herein by reference in its entirety.

### BACKGROUND

Large-scale computer networks can be built using distributed routing switches for transmitting packets of information. In large-scale networks, the links may be photonic. First, a photonic routing switch performs optical to electrical conversion. Then, signals are routed on-chip in the electrical domain. Subsequently, the photonic routing switch performs electrical to optical conversion. Lastly, the resulting optical signals are transmitted to another routing switch or to a computer.

### BRIEF SUMMARY

Some embodiments relate to an optical switch, including: a plurality of input ports including a first input port and a second input port, wherein the first input port is configured to receive a first plurality of optical signals supporting respective wavelength division multiplexing (WDM) channels, and wherein the second input port is configured to receive a second plurality of optical signals supporting respective WDM channels; a plurality of waveguides including a first set of waveguides and a second set waveguides; a plurality of optical division multiplexers (ODMs) including a first ODM and a second ODM, wherein the first ODM is configured to route the first plurality of optical signals to respective waveguides of the first set of waveguides and the second ODM is configured to route the second plurality of optical signals to respective waveguides of the second set of waveguides; a plurality of optical-to-electrical converters coupled to the plurality of waveguides, wherein the plurality of optical-to-electrical converters includes: a first set of optical-to-electrical converters configured to receive, from the waveguides, optical signals supporting a first common WDM channel; and a second set of optical-to-electrical converters configured to receive, from the waveguides, optical signals supporting a second common WDM channel; a plurality of electrical-to-optical converters including a first electrical-to-optical converter coupled to the first set of optical-to-electrical converters and a second electrical-to-optical converter coupled to the second set of optical-to-electrical converters; and a plurality of output ports including a first output port coupled to the first electrical-to-optical converter and a second output port coupled to the second electrical-to-optical converter.

In some embodiments, the techniques described herein relate to an optical switch, wherein the optical switch lacks electrical routers.

In some embodiments, the techniques described herein relate to an optical switch, further including a first electrical router coupling the first set of optical-to-electrical converters to the first electrical-to-optical converter.

In some embodiments, the techniques described herein relate to an optical switch, further including: a third electrical-to-optical converter coupled to the first electrical router; and a third output port coupled to the third electrical-to-optical converter.

In some embodiments, the techniques described herein relate to an optical switch, further including: a second electrical router coupling the second set of optical-to-electrical converters to the second electrical-to-optical converter; a fourth electrical-to-optical converter coupled to the second electrical router; and a fourth output port coupled to the fourth electrical-to-optical converter.

In some embodiments, the techniques described herein relate to an optical switch, wherein the plurality of ODMs are passive optical components.

In some embodiments, the techniques described herein relate to an optical switch, wherein the plurality of waveguides, the plurality of ODMs, the plurality of optical-to-electrical converters and the plurality of electrical-to-optical converters are formed on a common chip.

Some embodiments relate to an optical switch configured to receive a plurality of optical signals via a plurality of optical input ports and a plurality of optical output ports, the optical switch including: at each port of the plurality of optical input ports, an optical division multiplexer (ODM) configured to receive optical signals having carrier wavelengths selected from a predetermined set of wavelengths; a plurality of waveguides coupled to an output of each ODM, each waveguide of the plurality of waveguides configured to carry one wavelength of the predetermined set of wavelengths; a plurality of optical-to-electrical converters, wherein each optical-to-electrical converter is configured to receive light from each of the plurality of waveguides associated with a particular wavelength of the predetermined set of wavelengths and to convert the received optical signals to electrical signals; a plurality of electrical-to-optical converters, wherein each electrical-to-optical converter is associated with a respective output port of a plurality of optical output ports and a respective optical-to-electrical converter of the plurality of the plurality of optical-to-electrical converters, wherein each electrical-to-optical converter is configured to, in response to receiving the electrical signals from the respective optical-to-electrical converter, transmit optical signals selected from the predetermined set of wavelengths from a respective one of the plurality of optical output ports.

In some embodiments, the techniques described herein relate to an optical switch, wherein the optical switch does not include an electrical router.

In some embodiments, the techniques described herein relate to an optical switch, wherein the ODMs are passive optical components.

In some embodiments, the techniques described herein relate to an optical switch, wherein one or more of the plurality of wavelengths is used for clock forwarding and the remaining wavelengths of the plurality of wavelengths are used for data.

In some embodiments, the techniques described herein relate to an optical switch, further including a plurality of electrical routers, each located between a respective one of the plurality of optical-to-electrical converters and a subset of the plurality of electrical-to-optical converters.

In some embodiments, the techniques described herein relate to an optical switch, wherein multiple output ports of the plurality of output ports share a common electrical router of the plurality of electrical routers.

Some embodiments relate to a system, including: a plurality of optical switches including first, second and third optical switches, the first optical switch having a first and second input ports, a first output port coupled to the second optical switch and a second output port coupled to the third optical switch, wherein the first input port is configured to receive a first plurality of optical signals supporting respective wavelength division multiplexing (WDM) channels, and wherein the second input port is configured to receive a second plurality of optical signals supporting respective WDM channels, wherein the first optical switch further includes: a plurality of waveguides including a first set of waveguides and a second set waveguides; a plurality of optical division multiplexers (ODMs) including a first ODM and a second ODM, wherein the first ODM is configured to route the first plurality of optical signals to respective waveguides of the first set of waveguides and the second ODM is configured to route the second plurality of optical signals to respective waveguides of the second set of waveguides; a plurality of optical-to-electrical converters coupled to the plurality of waveguides, wherein the plurality of optical-to-electrical converters includes: a first set of optical-to-electrical converters configured to receive, from the waveguides, optical signals supporting a first common WDM channel; and a second set of optical-to-electrical converters configured to receive, from the waveguides, optical signals supporting a second common WDM channel; and a plurality of electrical-to-optical converters including a first electrical-to-optical converter coupled to the first set of optical-to-electrical converters and a second electrical-to-optical converter coupled to the second set of optical-to-electrical converters, wherein the first output port couples the first electrical-to-optical converter to the second optical switch and the second output port couples the second electrical-to-optical converter to the third optical switch.

In some embodiments, the techniques described herein relate to a system, wherein the first optical switch lacks electrical routers.

In some embodiments, the techniques described herein relate to a system, wherein the first optical switch further includes a first electrical router coupling the first set of optical-to-electrical converters to the first electrical-to-optical converter.

In some embodiments, the techniques described herein relate to a system, wherein the first optical switch further includes: a third electrical-to-optical converter coupled to the first electrical router; and a third output port coupled to the third electrical-to-optical converter.

In some embodiments, the techniques described herein relate to a system, wherein the first optical switch further includes: a second electrical router coupling the second set of optical-to-electrical converters to the second electrical-to-optical converter; a fourth electrical-to-optical converter coupled to the second electrical router; and a fourth output port coupled to the fourth electrical-to-optical converter.

In some embodiments, the techniques described herein relate to a system, wherein the plurality of ODMs are passive optical components.

In some embodiments, the techniques described herein relate to a system, wherein the plurality of waveguides, the plurality of ODMs, the plurality of optical-to-electrical converters and the plurality of electrical-to-optical converters are formed on a common chip.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1 is a block diagram illustrating a conventional 8-port unidirectional switch chip.

FIG. 2 is a block diagram illustrating a wavelength division multiplexing (WDM)-based unidirectional switch chip, according to some embodiments.

FIG. 3 is a block diagram illustrating a system including multiple WDM-based switch chips, according to some embodiments.

FIG. 4 is a block diagram illustrating a WDM-based unidirectional switch chip including an electrical routing stage, according to some embodiments.

### DETAILED DESCRIPTION

Described herein are optical switches that leverage wavelength division multiplexing (WDM) to route signals to the desired destination. The optical switches developed by the inventors represent a significant advancement over conventional designs in several critical areas.

In large-scale computer systems, efficient communication between components is critical to overall system performance. Specifically, it is desirable to achieve high bandwidth (to transfer large volumes of data quickly) and low latency (to minimize delays in data transmission). These attributes are essential to support parallel processing, real-time applications, and large-scale data analytics, where communication delays and bottlenecks can severely degrade computational throughput.

The inventors have recognized and appreciated that the conventional approach for routing signals within large-scale computer systems, which relies on electrical wires, presents several challenges. At the high frequencies required to support high-bandwidth communication, electrical wires exhibit significant latency and power consumption. This degradation arises from signal attenuation and capacitive behavior, which become increasingly pronounced at higher data rates and over longer distances.

Aspects of the present disclosure are directed to switching schemes designed to limit energy consumption and latency by reducing the distance an electrical signal has to traverse between the input and the output of a switch. The inventors propose a switching scheme that uses WDM to route signals to the desired destination. In some embodiments, each source/destination pair may be encoded on a particular WDM channel. For example, a device that intends to transmit a message from an input port to a particular output port may encode the message on a WDM channel that is uniquely associated with that output port. This approach presents a significant advantage over conventional switching architectures in that it removes the requirement to use stages of electrical routing, thereby reducing power consumption and signal latency.

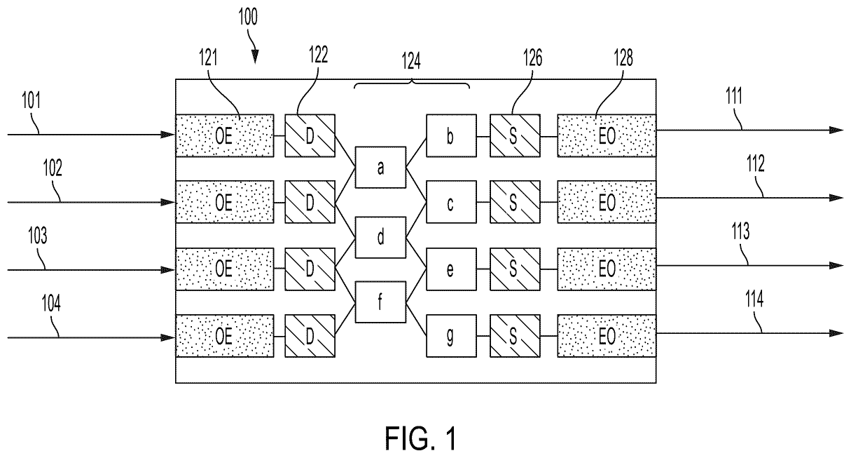

Conventionally, switches can be implemented using application-specific integrated circuits (ASIC), often referred to simply as “switch chips,” “routing chips” or “routing switches.” FIG. 1 illustrates a conventional 8-port unidirectional switch chip 100. Switch chip 100 includes four input ports connected to respective fibers (101, 102, 103 and 104) and four output ports connected to respective fibers (111, 112, 113 and 114). While switch chip 100 includes four input ports and four output ports for convenience of illustration, it should be understood that a larger (or smaller) number of input fibers and output fibers may be used. Switch chip 100 is “unidirectional” in that signals are generally transmitted from the input ports to the output ports, and not vice versa.

Switch chip 100 includes optical-to-electrical (OE) converters 121, deserializers 122, electrical routers 124 (labelled “a,” “b,” “c,” “d,” “e,” “f,” “g”), serializers 126, and electrical-to-optical (EO) converters 128. Each optical-to-electrical converter 121 is configured to convert the optical signal received through a respective input fiber into an electrical signal. For example, each optical-to-electrical converter 121 may include a photodetector, a transimpedance amplifier and an analog-to-digital converter. Similarly, each electrical-to-optical converter 128 is configured to convert the electrical signal received from a respective serializer 126 into an optical signal. For example, each electrical-to-optical converter 128 may include a digital-to-analog converter, an amplifier, and an optical modulator. A light source may provide light to the optical modulators. The optical signals are transmitted outside switch chip 100 through the output fibers. Deserializers 122 are configured to deserialize the electrical signals produced by the optical-to-electrical converters and serializers 126 are configured to serialize electrical signals prior to conversion by the electrical-to-optical converters.

Electrical routers 124 form the switching fabric of switch chip 100. In the example shown in FIG. 1, switch chip 100 includes seven electrical routers arranged in two stages. The electrical routers labelled “a,” “d” and “f” are part of the first stage and the electrical routers labelled “b,” “c,” “e” and “g” are part of the second stage. Each electrical router of the first stage is coupled to a pair of deserializers and a pair of electrical routers of the second stage. Each electrical router of the second stage is coupled to a pair of electrical routers of the first stage and a serializer (with the exception of electrical routers “b” and “g,” which are only coupled to one electrical router of the first stage).

As can be appreciated from FIG. 1, incoming data signals may have to pass through multiple electrical routers to be directed to the desired output fiber. The inventors have recognized and appreciated that this scheme is inefficient because for each electrical router through which a signal passes there is a corresponding increase in power consumption and signal latency. Consider for example the electrical routers through which an incoming signal provided by input fiber 101 has to pass before exiting output fiber 114. After passing through an optical-to-electrical converter 121 and the associated deserializer 122, the data signal traverses several electrical routers, in the following order: “a,” “c,” “d,” “e,” “f” and “g.” Thus, the data signal traverses six separate electrical routers between input fiber 101 and output fiber 114. As a result, the total distance traveled by the electrical signal is greater than or equal to the vertical distance between input fiber 101 and output fiber 114.

The inventors have developed switch chip designs that reduce power consumption and signal latency by reducing the electrical distance that a data signal has to traverse before reaching its destination. This is accomplished using wavelength division multiplexing (WDM). WDM is a technique used in fiber-optic communications to transmit multiple data streams simultaneously over a single optical fiber by using different wavelengths (colors) of light for each stream. Conventionally, WDM is used to make efficient use of a fiber—a single packet of information is encoded in parallel into multiple signals, where each signal is carried by a different WDM channel. In this way, if N different WDM channels are used, N bytes of information can be received in parallel at the same time, representing a significant improvement over systems in which N bytes are received serially over N units of time. In conventional WDM-based switching, a switch chip decodes every WDM channel at the receiving block and re-routes the signal through the chip electronically.

The inventors propose using WDM in a different way relative to conventional WDM-based architectures. In some embodiments, a switch chip distributes optical signals to be near the output ports of the chip and decodes the optical signals near the output port, thereby eliminating the need for electrical routing. This can be achieved by optically demultiplexing (e.g., physically separating) individual WDM channels as they are received and using on-chip waveguides to transport them. In one aspect of the present disclosure, each source/destination pair may be encoded on a particular WDM channel. Consider for example a scenario in which a device intends to transmit a message from the first of several input ports to the first of several output ports. In this scenario, the device encodes the message on an optical signal supporting a WDM channel corresponding to λ₂. However, if the device intends to transmit a message from the first input port to the second output port, the device encodes the message on an optical signal supporting a WDM channel corresponding to λ₂. Similarly, if the device intends to transmit a message from the first input port to the third output port, the device encodes the message on an optical signal supporting a WDM channel corresponding to λ₃. This approach presents a significant advantage over conventional switching architectures—it removes the requirement to use stages of electrical routing, thereby reducing power consumption and signal latency. Instead, routing is performed on the basis of which WDM channel is encoded with the incoming data stream.

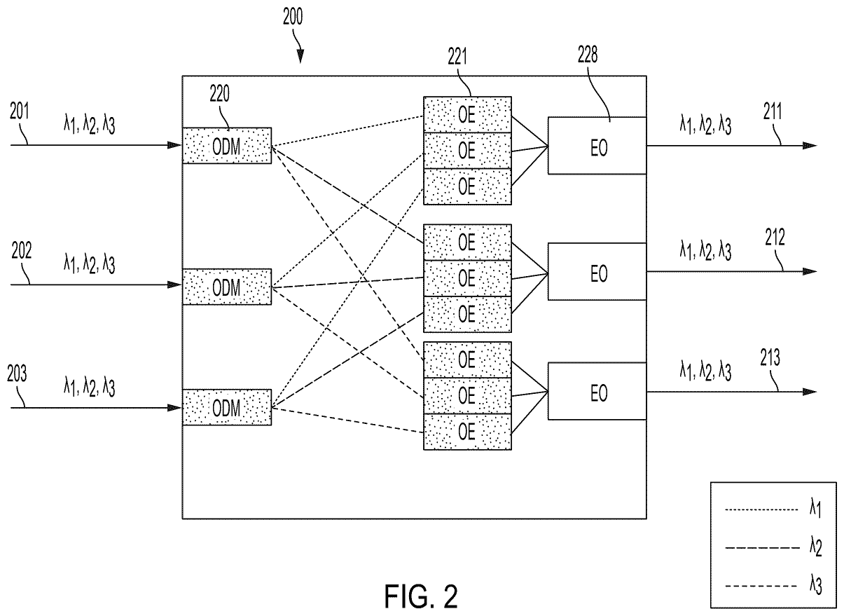

FIG. 2 is a block diagram illustrating a WDM-based unidirectional switch chip, according to some embodiments. Switch chip 200 includes three input ports connected to respective fibers (201, 202 and 203) and three output ports connected to respective fibers (211, 212 and 213). While switch chip 200 includes three input ports and three output ports for convenience of illustration, it should be understood that a larger (or smaller) number of input ports and/or a larger (or smaller) number of output ports may be used. In this example, each fiber carries three WDM channels. WDM channels of the types described herein form wavelength intervals used to perform optical communication consistent with WDM techniques. Each WDM channel is characterized by a corresponding carrier wavelength. A carrier wavelength of a WDM channel may be the wavelength positioned in the middle of the wavelength interval of a WDM channel. Alternatively or additionally, a carrier wavelength of a WDM channel may be the wavelength that exhibits the absolute peak intensity within the wavelength interval of a WDM channel. Alternatively or additionally, a carrier wavelength of a WDM channel may be the nominal wavelength of emission of an optical source. The wavelength of emission may be “nominal” in that the optical source may emit a finite spectrum of wavelengths around the nominal wavelength due to spectral broadening effects.

Switch chip 200 includes an optical demultiplexer (ODM) 220 (also referred to as a demux) for each input fiber. Each ODM 220 spatially separates the WDM channels carried by the corresponding input fiber. Each WDM channel is coupled to a respective on-chip optical waveguide. Each waveguide couples light at a particular wavelength interval to an optical-to-electrical converter (OE) 221 located adjacent to a corresponding output port. ODMs 220 may be passive optical components; as such, the demultiplexing scheme may be static. Static schemes are beneficial in that they limit power consumption and latency. Alternatively, ODMs 220 may include active optical components, thereby enabling dynamic demultiplexing schemes. In some embodiments, ODMs 220 may be implemented using non-linear optical components. In some embodiments, the waveguides of switch chip 200 may include optical amplifiers.

Once in the electrical domain, each signal is first decoded, and subsequently re-encoded to the appropriate WDM channel. The output WDM channel is selected based on the destination output port. At the output of switch chip 200, each electrical-to-optical converter (EO) 228 is configured to convert the electrical signal received from a respective optical-to-electrical converter 221 into an optical signal.

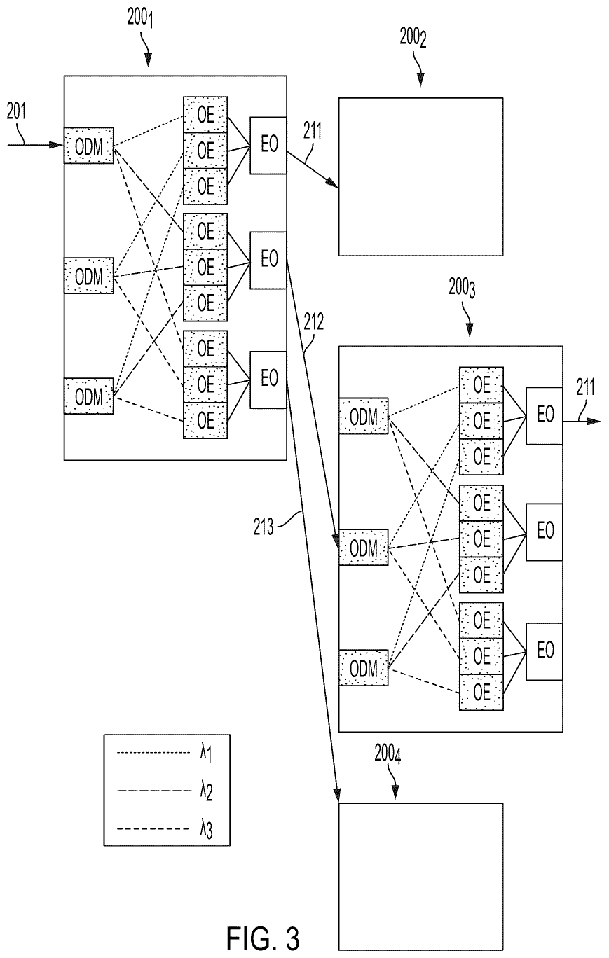

In more detail, each input fiber of switch chip 200 carries three WDM channels. The WDM channels are identified by their carrier wavelength (λ₁, λ₂ and λ₃). More or fewer WDM channels may be used in some embodiments. ODMs 220 demultiplex and route the WDM channels towards output fibers as depicted in FIG. 2. For example, the ODMs 220 may route all the WDM channels identified by wavelength λ₁ towards output fiber 211, all the WDM channels identified by wavelength λ₂ towards output fiber 212 and all the WDM channels identified by wavelength λ₃ towards output fiber 213. After electrical conversion by OE converters 221, the information is converted back into the optical domain using EO converters 228 for transmission through fibers 211, 212 and 213. The WDM channels on which the optical signals are re-encoded are chosen on the basis of the subsequent hop, as can be appreciated from the example of FIG. 3.

In the depiction of FIG. 2, OE converters 221 are grouped together on the basis of receiving common WDM channels. For example, the set of OE converters 221 that is coupled to output fiber 211 receives optical signal supporting a common WDM channel, the WDM channel corresponding to λ₁. Similarly, the set of OE converters 221 that is coupled to output fiber 212 receives optical signal supporting a common WDM channel, the WDM channel corresponding to λ₂. Lastly, the set of OE converters 221 that is coupled to output fiber 213 receives optical signal supporting a common WDM channel, the WDM channel corresponding to λ₃.

Switch chip 200 may be used in a system including multiple switch chips of the types illustrated in FIG. 2. In such a system, a message may traverse multiple switch chips before reaching its ultimate destination. FIG. 3 shows a system including multiple switch chips, according to some embodiments. In this example, the system includes four switch chips of the types depicted in FIG. 2. The switch chips are organized in two layers, although several additional layers may be included. Switch chip 200₁ defines the first layer. Switch chips 200₂, 200₃ and 200₄ define the second layer. Switch chip 200₂ is coupled to output fiber 211 of switch chip 200₁; switch chip 200₃ is coupled to output fiber 212 of switch chip 200₁; switch chip 200₄ is coupled to output fiber 213 of switch chip 200₁. The other input ports of switch chips 200₂, 200₃ and 200₄ may be coupled to other switch chips not illustrated in FIG. 3. Though not illustrated, switch chips 200₂ and 200₄ may be implemented using the same design shown for switch chips 200₁ and 200₃.

In this illustrative example, the system is configured to route a message received by switch chip 200₁ through input fiber 201 to output fiber 211 of switch chip 200₃. At each layer, optical signals are encoded on a WDM channel chosen on the basis of the subsequent layer. At input fiber 201 (of switch chip 200₁), the message is encoded on the WDM channel corresponding to center wavelength λ₂ to indicate that the message is supposed to be routed to output fiber 212 (of switch chip 200₁). Subsequently, at input fiber 212 (of switch chip 200₃), the message is encoded on the WDM channel corresponding to center wavelength λ₁ to indicate that the message is supposed to be routed to output fiber 211 (of switch chip 200₃). Each switch chip determines the destination of a message, for example, by reading the message header (or using other logic). On the basis of that determination, the EO converters 228 select the WDM channel on which the message is to be encoded.

In some embodiments, one or more of the plurality of wavelengths is used for clock forwarding and the remaining wavelengths of the plurality of wavelengths are used for data.

The inventors have recognized a potential limitation associated with the switch chip design of FIG. 2. In cases where a switch chip has a large radix (e.g., a large number of input ports and/or a large number of output ports), there may be insufficient WDM channels to support the routing scheme described in connection with FIG. 3. Generally, there are several factors that can limit the number of channels supported by WDM optical systems. One of these factors is the limited free spectral range (FSR) of common multiplexers and demultiplexers.

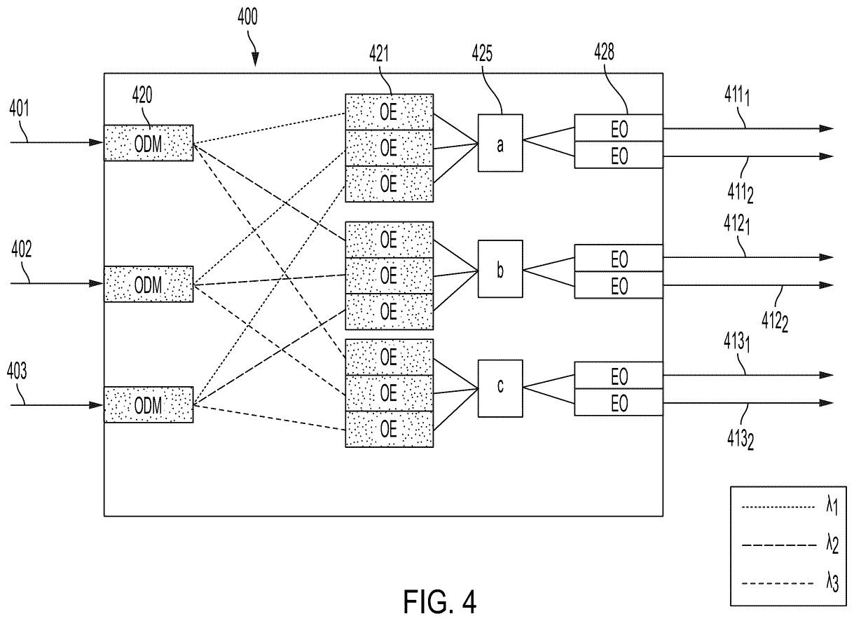

To obviate the limited number of available WDM channels, the inventors propose combining the WDM-based scheme described in connection with FIGS. 2-3 with a local electrical routing stage. This electrical routing stage is said to be local in that it is performed near the output ports of a switch chip. This modified architecture is depicted in FIG. 4. FIG. 4 is a block diagram illustrating a WDM-based unidirectional switch chip including an electrical routing stage, according to some embodiments. Switch chip 400 is similar to switch chip 200 in that it is connected to three input fibers (401, 402 and 403), and includes ODMs 420, OE converters 421 and EO converters 428. Similar to switch chip 200, switch chip 400 supports three WDM channels. However, switch chip 400 is connected to six output fibers (411₁, 411₂, 412₁, 412₂, 413₁ and 413₂), which exceeds the number of available WDM channels. To support the WDM-based scheme described above despite the shortage of WDM channels, switch chip 400 further includes an electrical routing stage 425 between OE converters 421 and EO converters 428. The electrical routers of stage 425 are labelled “a,” “b” and “c.” Each electrical router receives electrical signals corresponding to a particular WDM channel. For example, electrical router “a” receives electrical signals resulting from the optical-to-electrical conversion of optical signals in the WDM channel corresponding to carrier wavelength λ₁; electrical router “b” receives electrical signals resulting from the optical-to-electrical conversion of optical signals in the WDM channel corresponding to carrier wavelength λ₂; electrical router “c” receives electrical signals resulting from the optical-to-electrical conversion of optical signals in the WDM channel corresponding to carrier wavelength λ₃. Each electrical router feeds a pair of EO converters 428 (or more than two EO converters in some embodiments). Although switch chip 400 involves a degree of electrical routing, the negative effects associated with conventional electrical routing described in connection with FIG. 1 are significantly diminished. This is because, in FIG. 4, electrical routing is only performed locally (as opposed to globally, as in the example of FIG. 1). To illustrate the difference between global and local electrical routing, consider an example in which switch chip 400 is supposed to route a message from input fiber 401 to output fiber 413₂. A similar example is described above in connection with FIG. 1, resulting in the message traversing as many as six electrical routers. In the example of FIG. 4, on the other hand, the message traverses only one electrical router (“c”). Routing in the vertical dimension is performed primarily in the optical domain.

In an alternative configuration, some embodiments use on-chip optical multicasting schemes. In this configuration, data is delivered to multiple parts of a chip switch simultaneously, where it can then be selected or dropped as appropriate.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. An optical switch, comprising:
a plurality of input ports comprising a first input port and a second input port, wherein the first input port is configured to receive a first plurality of optical signals supporting respective wavelength division multiplexing (WDM) channels, and wherein the second input port is configured to receive a second plurality of optical signals supporting respective WDM channels;
a plurality of waveguides comprising a first set of waveguides and a second set waveguides;
a plurality of optical division multiplexers (ODMs) comprising a first ODM and a second ODM, wherein the first ODM is configured to route the first plurality of optical signals to respective waveguides of the first set of waveguides and the second ODM is configured to route the second plurality of optical signals to respective waveguides of the second set of waveguides;
a plurality of optical-to-electrical converters coupled to the plurality of waveguides, wherein the plurality of optical-to-electrical converters comprises:
a first set of optical-to-electrical converters configured to receive, from the waveguides, optical signals supporting a first common WDM channel; and
a second set of optical-to-electrical converters configured to receive, from the waveguides, optical signals supporting a second common WDM channel;
a plurality of electrical-to-optical converters comprising a first electrical-to-optical converter coupled to the first set of optical-to-electrical converters and a second electrical-to-optical converter coupled to the second set of optical-to-electrical converters; and
a plurality of output ports comprising a first output port coupled to the first electrical-to-optical converter and a second output port coupled to the second electrical-to-optical converter.

2. The optical switch of claim 1, wherein the optical switch lacks electrical routers.

3. The optical switch of claim 1, further comprising a first electrical router coupling the first set of optical-to-electrical converters to the first electrical-to-optical converter.

4. The optical switch of claim 3, further comprising:
a third electrical-to-optical converter coupled to the first electrical router; and
a third output port coupled to the third electrical-to-optical converter.

5. The optical switch of claim 4, further comprising:
a second electrical router coupling the second set of optical-to-electrical converters to the second electrical-to-optical converter;
a fourth electrical-to-optical converter coupled to the second electrical router; and
a fourth output port coupled to the fourth electrical-to-optical converter.

6. The optical switch of claim 1, wherein the plurality of ODMs are passive optical components.

7. The optical switch of claim 1, wherein the plurality of waveguides, the plurality of ODMs, the plurality of optical-to-electrical converters and the plurality of electrical-to-optical converters are formed on a common chip.

8. An optical switch configured to receive a plurality of optical signals via a plurality of optical input ports and a plurality of optical output ports, the optical switch comprising:
at each port of the plurality of optical input ports, an optical division multiplexer (ODM) configured to receive optical signals having carrier wavelengths selected from a predetermined set of wavelengths;
a plurality of waveguides coupled to an output of each ODM, each waveguide of the plurality of waveguides configured to carry one wavelength of the predetermined set of wavelengths;
a plurality of optical-to-electrical converters, wherein each optical-to-electrical converter is configured to receive light from each of the plurality of waveguides associated with a particular wavelength of the predetermined set of wavelengths and to convert the received optical signals to electrical signals; and
a plurality of electrical-to-optical converters, wherein each electrical-to-optical converter is associated with a respective output port of a plurality of optical output ports and a respective optical-to-electrical converter of the plurality of the plurality of optical-to-electrical converters, wherein each electrical-to-optical converter is configured to, in response to receiving the electrical signals from the respective optical-to-electrical converter, transmit optical signals selected from the predetermined set of wavelengths from a respective one of the plurality of optical output ports.

9. The optical switch of claim 8, wherein the optical switch does not include an electrical router.

10. The optical switch of claim 8, wherein the ODMs are passive optical components.

11. The optical switch of claim 8, wherein one or more of the plurality of wavelengths is used for clock forwarding and the remaining wavelengths of the plurality of wavelengths are used for data.

12. The optical switch of claim 8, further comprising a plurality of electrical routers, each located between a respective one of the plurality of optical-to-electrical converters and a subset of the plurality of electrical-to-optical converters.

13. The optical switch of claim 12, wherein multiple output ports of the plurality of output ports share a common electrical router of the plurality of electrical routers.

14. A system, comprising:
a plurality of optical switches comprising first, second and third optical switches, the first optical switch having a first and second input ports, a first output port coupled to the second optical switch and a second output port coupled to the third optical switch, wherein the first input port is configured to receive a first plurality of optical signals supporting respective wavelength division multiplexing (WDM) channels, and wherein the second input port is configured to receive a second plurality of optical signals supporting respective WDM channels, wherein the first optical switch further comprises:
a plurality of waveguides comprising a first set of waveguides and a second set waveguides;
a plurality of optical division multiplexers (ODMs) comprising a first ODM and a second ODM, wherein the first ODM is configured to route the first plurality of optical signals to respective waveguides of the first set of waveguides and the second ODM is configured to route the second plurality of optical signals to respective waveguides of the second set of waveguides;
a plurality of optical-to-electrical converters coupled to the plurality of waveguides, wherein the plurality of optical-to-electrical converters comprises:
a first set of optical-to-electrical converters configured to receive, from the waveguides, optical signals supporting a first common WDM channel; and
a second set of optical-to-electrical converters configured to receive, from the waveguides, optical signals supporting a second common WDM channel; and
a plurality of electrical-to-optical converters comprising a first electrical-to-optical converter coupled to the first set of optical-to-electrical converters and a second electrical-to-optical converter coupled to the second set of optical-to-electrical converters,
wherein the first output port couples the first electrical-to-optical converter to the second optical switch and the second output port couples the second electrical-to-optical converter to the third optical switch.

15. The system of claim 14, wherein the first optical switch lacks electrical routers.

16. The system of claim 14, wherein the first optical switch further comprises a first electrical router coupling the first set of optical-to-electrical converters to the first electrical-to-optical converter.

17. The system of claim 16, wherein the first optical switch further comprises:
a third electrical-to-optical converter coupled to the first electrical router; and
a third output port coupled to the third electrical-to-optical converter.

18. The system of claim 17, wherein the first optical switch further comprises:
a second electrical router coupling the second set of optical-to-electrical converters to the second electrical-to-optical converter;
a fourth electrical-to-optical converter coupled to the second electrical router; and
a fourth output port coupled to the fourth electrical-to-optical converter.

19. The system of claim 14, wherein the plurality of ODMs are passive optical components.

20. The system of claim 14, wherein the plurality of waveguides, the plurality of ODMs, the plurality of optical-to-electrical converters and the plurality of electrical-to-optical converters are formed on a common chip.
